(19) United States
(12) Patent Application Publication
(10) Pub. No.: US 2012/0120428 A1
(43) Pub. Date: May 17, 2012

(54) SCANNING PATCHES TO PROVIDE PRINTER CALIBRATION DATA

(76) Inventor: THOMAS A. HENDERSON, Rochester, NY (US)

(21) Appl. No.: 12/944,960

(22) Filed: Nov. 12, 2010

(51) Int. Cl. G06F 3/12

(52) U.S. Cl. 358/1.13

(57) ABSTRACT

A method of providing calibration data for a printer includes printing a calibration target using the printer, the target including first and second patch sets, each patch set including a plurality of test patches. An operator scans one or both sets using an external scanner to provide scanned patch data. A processor automatically determines which set(s) have been scanned. Calibration data are automatically generated for the printer using the scanned patch data.

### FIELD OF THE INVENTION

This invention pertains to the field of printing and more particularly to color calibration of a printer.

### BACKGROUND OF THE INVENTION

Electrophotography is a useful process for printing images on a receiver (or “imaging substrate”), such as a piece or sheet of paper or another planar medium, glass, fabric, metal, or other objects as will be described below. In this process, an electrostatic latent image is formed on a photoreceptor by uniformly charging the photoreceptor and then discharging selected areas of the uniform charge to yield an electrostatic charge pattern corresponding to the desired image (a “latent image”).

After the latent image is formed, charged toner particles are brought into the vicinity of the photoreceptor and are attracted to the latent image to develop the latent image into a visible image. Note that the visible image may not be visible to the naked eye depending on the composition of the toner particles (e.g. clear toner).

After the latent image is developed into a visible image on the photoreceptor, a suitable receiver is brought into juxtaposition with the visible image. A suitable electric field is applied to transfer the toner particles of the visible image to the receiver to form the desired print image on the receiver. The imaging process is typically repeated many times with reusable photoreceptors.

The receiver is then removed from its operative association with the photoreceptor and subjected to heat or pressure to permanently fix (“fuse”) the print image to the receiver. Plural print images, e.g. of separations of different colors, are overlaid on one receiver before fusing to form a multi-color print image on the receiver.

Electrophotographic (EP) printers typically transport the receiver past the photoreceptor to form the print image. The direction of travel of the receiver is referred to as the slow-scan, process, or in-track direction. This is typically the vertical (Y) direction of a portrait-oriented receiver. The direction perpendicular to the slow-scan direction is referred to as the fast-scan, cross-process, or cross-track direction, and is typically the horizontal (X) direction of a portrait-oriented receiver. “Scan” does not imply that any components are moving or scanning across the receiver; the terminology is conventional in the art.

Variations in the operational parameters of a printer while printing can cause variations in color and tone reproduction between and within jobs. Printers are calibrated by printing test targets of known colors, measuring the colors reproduced by the printer, and comparing those measurements to the known colors to determine correction factors. Flatbed scanners can be used to scan printed targets. However, flatbed scanners are most often colorimetric instruments, not spectroradiometric instruments. That is, flatbed scanners represent each color as a match of three corresponding primaries. Spectroradiometers, by contrast, measure the full spectrum of light reflected from each patch, permitting much more accurate measurements and effective compensations. However, spectroradiometers are most often capable of measuring only one sample at a time; typical test targets include many samples. Spectroradiometer measurements are often taken by hand, one patch at a time, by an operator using an instrument such as an I1BASIC from X-RITE, INC.

U.S. Pat. No. 6,441,923 to Balasubramanian et al. describes generating a calibration target dynamically in response to selected printer variables. The whole target is measured and used for calibration. This scheme is, therefore, not optimized for use with handheld scanners. It requires scanning many patches.

U.S. Pat. No. 6,972,867 to Venable et al. describes encoding job identification data on the calibration target. This scheme permits determining the orientation of a target placed on a flatbed scanner, but does not assist an operator in performing hand scans with a spectroradiometer or other handheld scanner.

There is a need, therefore, for a method of providing calibration data for a printer that reduces operator workload while providing accurate results.

### SUMMARY OF THE INVENTION

According to an aspect of the present invention, there is provided a method of providing calibration data for a printer, comprising:

printing a calibration target using the printer, the target including first and second patch sets, each patch set including a plurality of test patches;

an operator scanning one or both sets using an external scanner to provide scanned patch data;

automatically determining, using a processor, which set(s) have been scanned; and

automatically generating calibration data for the printer using the scanned patch data.

According to another aspect of the invention, there is provided a method of providing calibration data for a printer, comprising:

printing a calibration target on a receiver using the printer, the target including a required patch set and an optional patch set, the optional patch set arranged spatially on the receiver before the required patch set in a scan order, each patch set including at least one test strip, each test strip including a plurality of test patches;

an operator scanning a first test strip of a first one of the patch sets using an external scanner to provide first scanned patch data;

automatically determining, using a processor, whether the first one of the patch sets is the required set or the optional set based on the first scanned patch data;

selecting a number of additional strips to scan corresponding to the determined first one of the patch sets;

the operator scanning the selected number of additional strips in the scan order to provide additional scanned patch data; and

automatically generating calibration data for the printer using the first scanned patch data and the additional scanned patch data.

An advantage of this invention is that it removes the need for the operator to always scan patches in a fixed order. It is therefore more robust in the presence of human error than previous schemes. Various embodiments reduce the time required to calibrate a printer and thereby improve printer throughput. This invention can be applied to a wide range of test targets, advantageously providing greater flexibility to the designer of a target. Various embodiments are applicable to a wide range of printing technologies.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is an elevational cross-section of an electrophotographic reproduction apparatus suitable for use with this invention;

FIG. 2 is a schematic of a data-processing path useful with the present invention;

FIG. 3 is a flowchart of a method of providing calibration data for a printer according to an embodiment;

FIG. 4 is a flowchart of details of various embodiments of step 330 of FIG. 3;

FIG. 5 is a flowchart of details of one embodiment of step 340 of FIG. 3;

FIGS. 6A and 6B are representations of test targets according to various embodiments;

FIG. 7 is a high-level diagram showing the components of a processing system useful with various embodiments;

FIG. 8 is a representation of a test target according to another embodiment; and

FIG. 9 is a flowchart of a method of providing calibration data for a printer according to another embodiment.

The attached drawings are for purposes of illustration and are not necessarily to scale.

### DETAILED DESCRIPTION OF THE INVENTION

As used herein, the terms “parallel” and “perpendicular” have a tolerance of ±10°.

As used herein, “sheet” is a discrete piece of media, such as receiver media for an electrophotographic printer (described below). Sheets have a length and a width. Sheets are folded along fold axes, e.g. positioned in the center of the sheet in the length dimension, and extending the full width of the sheet. The folded sheet contains two “leaves,” each leaf being that portion of the sheet on one side of the fold axis. The two sides of each leaf are referred to as “pages.” “Face” refers to one side of the sheet, whether before or after folding.

In the following description, some embodiments of the present invention will be described in terms that would ordinarily be implemented as software programs. Those skilled in the art will readily recognize that the equivalent of such software can also be constructed in hardware. Because image manipulation algorithms and systems are well known, the present description will be directed in particular to algorithms and systems forming part of, or cooperating more directly with, the method in accordance with the present invention. Other aspects of such algorithms and systems, and hardware or software for producing and otherwise processing the image signals involved therewith, not specifically shown or described herein, are selected from such systems, algorithms, components, and elements known in the art. Given the system as described according to the invention in the following, software not specifically shown, suggested, or described herein that is useful for implementation of the invention is conventional and within the ordinary skill in such arts.

The phrase, “digital image file”, as used herein, refers to any digital image file, such as a digital still image or a digital video file.

A computer program product can include one or more storage media, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

As used herein, “toner particles” are particles of one or more material(s) that are transferred by an EP printer to a receiver to produce a desired effect or structure (e.g. a print image, texture, pattern, or coating) on the receiver. Toner particles can be ground from larger solids, or chemically prepared (e.g. precipitated from a solution of a pigment and a dispersant using an organic solvent), as is known in the art. Toner particles can have a range of diameters, e.g. less than 8 μm, on the order of 10-15 μm, up to approximately 30 μm, or larger (“diameter” refers to the volume-weighted median diameter, as determined by a device such as a Coulter Multisizer).

“Toner” refers to a material or mixture that contains toner particles, and that can form an image, pattern, or coating when deposited on an imaging member including a photoreceptor, a photoconductor, or an electrostatically-charged or magnetic surface. Toner can be transferred from the imaging member to a receiver. Toner is also referred to in the art as marking particles, dry ink, or developer, but note that herein “developer” is used differently, as described below. Toner can be a dry mixture of particles or a suspension of particles in a liquid toner base.

Toner includes toner particles and can include other particles. Any of the particles in toner can be of various types and have various properties. Such properties can include absorption of incident electromagnetic radiation (e.g. particles containing colorants such as dyes or pigments), absorption of moisture or gasses (e.g. desiccants or getters), suppression of bacterial growth (e.g. biocides, particularly useful in liquid-toner systems), adhesion to the receiver (e.g. binders), electrical conductivity or low magnetic reluctance (e.g. metal particles), electrical resistivity, texture, gloss, magnetic remnance, florescence, resistance to etchants, and other properties of additives known in the art.

In single-component or monocomponent development systems, “developer” refers to toner alone. In these systems, none, some, or all of the particles in the toner can themselves be magnetic. However, developer in a monocomponent system does not include magnetic carrier particles. In dual-component, two-component, or multi-component development systems, “developer” refers to a mixture including toner particles and magnetic carrier particles, which can be electrically-conductive or -non-conductive. Toner particles can be magnetic or non-magnetic. The carrier particles can be larger than the toner particles, e.g. 15-20 μm or 20-300 μm in diameter. A magnetic field is used to move the developer in these systems by exerting a force on the magnetic carrier particles. The developer is moved into proximity with an imaging member or transfer member by the magnetic field, and the toner or toner particles in the developer are transferred from the developer to the member by an electric field, as will be described further below. The magnetic carrier particles are not intentionally deposited on the member by action of the electric field; only the toner is intentionally deposited. However, magnetic carrier particles, and other particles in the toner or developer, can be unintentionally transferred to an imaging member. Developer can include other additives known in the art, such as those listed above for toner. Toner and carrier particles can be substantially spherical or non-spherical.

Various types of printers can be calibrated as described herein. For example, continuous inkjet, drop-on-demand inkjet (as described in co-pending, commonly-assigned U.S. Ser. No. 12/642,883, the disclosure of which is incorporated herein by reference), thermal, electrophotographic, flexographic, and offset printers or presses can be calibrated as described herein. Electrophotography is described herein to provide an example of a printer which can be calibrated as described herein.

The electrophotographic process can be embodied in devices including printers, copiers, scanners, and facsimiles, and analog or digital devices, all of which are referred to herein as “printers.” Various aspects of the present invention are useful with electrostatographic printers such as electrophotographic printers that employ toner developed on an electrophotographic receiver, and ionographic printers and copiers that do not rely upon an electrophotographic receiver. Electrophotography and ionography are types of electrostatography (printing using electrostatic fields), which is a subset of electrography (printing using electric fields).

A digital reproduction printing system (“printer”) typically includes a digital front-end processor (DFE), a print engine (also referred to in the art as a “marking engine”) for applying toner to the receiver, and one or more post-printing finishing system(s) (e.g. a UV coating system, a glosser system, or a laminator system). A printer can reproduce pleasing black-and-white or color onto a receiver. A printer can also produce selected patterns of toner on a receiver, which patterns (e.g. surface textures) do not correspond directly to a visible image. The DFE receives input electronic files (such as Postscript command files) composed of images from other input devices (e.g., a scanner, a digital camera). The DFE can include various function processors, e.g. a raster image processor (RIP), image positioning processor, image manipulation processor, color processor, or image storage processor. The DFE rasterizes input electronic files into image bitmaps for the print engine to print. In some embodiments, the DFE permits a human operator to set up parameters such as layout, font, color, paper type, or post-finishing options. The print engine takes the rasterized image bitmap from the DFE and renders the bitmap into a form that can control the printing process from the exposure device to transferring the print image onto the receiver. The finishing system applies features such as protection, glossing, or binding to the prints. The finishing system can be implemented as an integral component of a printer, or as a separate machine through which prints are fed after they are printed.

The printer can also include a color management system which captures the characteristics of the image printing process implemented in the print engine (e.g. the electrophotographic process) to provide known, consistent color reproduction characteristics. The color management system can also provide known color reproduction for different inputs (e.g. digital camera images or film images).

In an embodiment of an electrophotographic modular printing machine useful with the present invention, e.g. the NEXPRESS 2100 printer manufactured by Eastman Kodak Company of Rochester, N.Y., color-toner print images are made in a plurality of color imaging modules arranged in tandem, and the print images are successively electrostatically transferred to a receiver adhered to a transport web moving through the modules. Colored toners include colorants, e.g. dyes or pigments, which absorb specific wavelengths of visible light. Commercial machines of this type typically employ intermediate transfer members in the respective modules for transferring visible images from the photoreceptor and transferring print images to the receiver. In other electrophotographic printers, each visible image is directly transferred to a receiver to form the corresponding print image.

Electrophotographic printers having the capability to also deposit clear toner using an additional imaging module are also known. The provision of a clear-toner overcoat to a color print is desirable for providing protection of the print from fingerprints and reducing certain visual artifacts. Clear toner uses particles that are similar to the toner particles of the color development stations but without colored material (e.g. dye or pigment) incorporated into the toner particles. However, a clear-toner overcoat can add cost and reduce color gamut of the print; thus, it is desirable to provide for operator/user selection to determine whether or not a clear-toner overcoat will be applied to the entire print. A uniform layer of clear toner can be provided. A layer that varies inversely according to heights of the toner stacks can also be used to establish level toner stack heights. The respective color toners are deposited one upon the other at respective locations on the receiver and the height of a respective color toner stack is the sum of the toner heights of each respective color. Uniform stack height provides the print with a more even or uniform gloss.

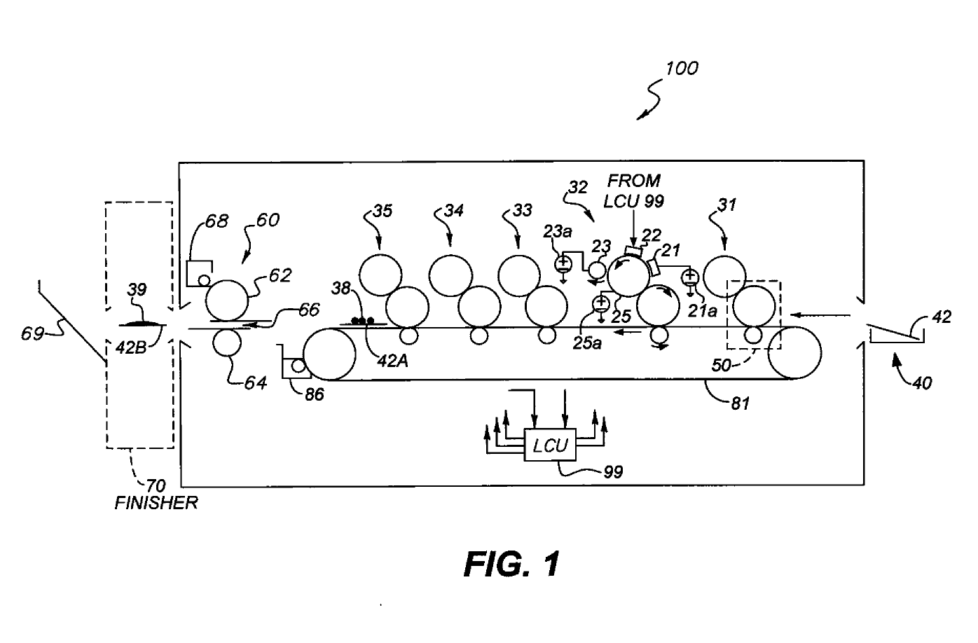

FIG. 1 is an elevational cross-section showing portions of a typical electrophotographic printer 100 useful with the present invention. Printer 100 is adapted to produce images, such as single-color (monochrome), CMYK, or pentachrome (five-color) images, on a receiver (multicolor images are also known as “multi-component” images). Images can include text, graphics, photos, and other types of visual content. One embodiment of the invention involves printing using an electrophotographic print engine having five sets of single-color image-producing or -printing stations or modules arranged in tandem, but more or less than five colors can be combined on a single receiver. Other electrophotographic writers or printer apparatus can also be included. Various components of printer 100 are shown as rollers; other configurations are also possible, including belts.

Referring to FIG. 1, printer 100 is an electrophotographic printing apparatus having a number of tandemly-arranged electrophotographic image-forming printing modules 31, 32, 33, 34, 35, also known as electrophotographic imaging subsystems. Each printing module produces a single-color toner image for transfer using a respective transfer subsystem 50 (for clarity, only one is labeled) to a receiver 42 successively moved through the modules. Receiver 42 is transported from supply unit 40, which can include active feeding subsystems as known in the art, into printer 100. In various embodiments, the visible image can be transferred directly from an imaging roller to a receiver, or from an imaging roller to one or more transfer roller(s) or belt(s) in sequence in transfer subsystem 50, and thence to receiver 42. Receiver 42 is, for example, a selected section of a web of, or a cut sheet of, planar media such as paper or transparency film.

Each receiver, during a single pass through the five modules, can have transferred in registration thereto up to five single-color toner images to form a pentachrome image. As used herein, the term “pentachrome” implies that in a print image, combinations of various of the five colors are combined to form other colors on the receiver at various locations on the receiver, and that all five colors participate to form process colors in at least some of the subsets. That is, each of the five colors of toner can be combined with toner of one or more of the other colors at a particular location on the receiver to form a color different than the colors of the toners combined at that location. In an embodiment, printing module 31 forms black (K) print images, 32 forms yellow (Y) print images, 33 forms magenta (M) print images, and 34 forms cyan (C) print images.

Printing module 35 can form a red, blue, green, or other fifth print image, including an image formed from a clear toner (i.e. one lacking pigment). The four subtractive primary colors, cyan, magenta, yellow, and black, can be combined in various combinations of subsets thereof to form a representative spectrum of colors. The color gamut or range of a printer is dependent upon the materials used and process used for forming the colors. The fifth color can therefore be added to improve the color gamut. In addition to adding to the color gamut, the fifth color can also be a specialty color toner or spot color, such as for making proprietary logos or colors that cannot be produced with only CMYK colors (e.g. metallic, fluorescent, or pearlescent colors), or a clear toner or tinted toner. Tinted toners absorb less light than they transmit, but do contain pigments or dyes that move the hue of light passing through them towards the hue of the tint. For example, a blue-tinted toner coated on white paper will cause the white paper to appear light blue when viewed under white light, and will cause yellows printed under the blue-tinted toner to appear slightly greenish under white light.

Receiver 42A is shown after passing through printing module 35. Print image 38 on receiver 42A includes unfused toner particles.

Subsequent to transfer of the respective print images, overlaid in registration, one from each of the respective printing modules 31, 32, 33, 34, 35, receiver 42A is advanced to a fuser 60, i.e. a fusing or fixing assembly, to fuse print image 38 to receiver 42A. Transport web 81 transports the print-image-carrying receivers to fuser 60, which fixes the toner particles to the respective receivers by the application of heat and pressure. The receivers are serially de-tacked from transport web 81 to permit them to feed cleanly into fuser 60. Transport web 81 is then reconditioned for reuse at cleaning station 86 by cleaning and neutralizing the charges on the opposed surfaces of the transport web 81. A mechanical cleaning station (not shown) for scraping or vacuuming toner off transport web 81 can also be used independently or with cleaning station 86. The mechanical cleaning station can be disposed along transport web 81 before or after cleaning station 86 in the direction of rotation of transport web 81.

Fuser 60 includes a heated fusing roller 62 and an opposing pressure roller 64 that form a fusing nip 66 therebetween. In an embodiment, fuser 60 also includes a release fluid application substation 68 that applies release fluid, e.g. silicone oil, to fusing roller 62. Alternatively, wax-containing toner can be used without applying release fluid to fusing roller 62. Other embodiments of fusers, both contact and non-contact, can be employed with the present invention. For example, solvent fixing uses solvents to soften the toner particles so they bond with the receiver. Photoflash fusing uses short bursts of high-frequency electromagnetic radiation (e.g. ultraviolet light) to melt the toner. Radiant fixing uses lower-frequency electromagnetic radiation (e.g. infrared light) to more slowly melt the toner. Microwave fixing uses electromagnetic radiation in the microwave range to heat the receivers (primarily), thereby causing the toner particles to melt by heat conduction, so that the toner is fixed to the receiver.

The receivers (e.g. receiver 42B) carrying the fused image (e.g., fused image 39) are transported in a series from the fuser 60 along a path either to a remote output tray 69, or back to printing modules 31, 32, 33, 34, 35 to create an image on the backside of the receiver, i.e. to form a duplex print. Receivers can also be transported to any suitable output accessory. For example, an auxiliary fuser or glossing assembly can provide a clear-toner overcoat. Printer 100 can also include multiple fusers 60 to support applications such as overprinting, as known in the art.

In various embodiments, between fuser 60 and output tray 69, receiver 42B passes through finisher 70. Finisher 70 performs various paper-handling operations, such as folding, stapling, saddle-stitching, collating, and binding.

Printer 100 includes main printer apparatus logic and control unit (LCU) 99, which receives input signals from the various sensors associated with printer 100 and sends control signals to the components of printer 100. LCU 99 can include a microprocessor incorporating suitable look-up tables and control software executable by the LCU 99. It can also include a field-programmable gate array (FPGA), programmable logic device (PLD), microcontroller, or other digital control system. LCU 99 can include memory for storing control software and data. Sensors associated with the fusing assembly provide appropriate signals to the LCU 99. In response to the sensors, the LCU 99 issues command and control signals that adjust the heat or pressure within fusing nip 66 and other operating parameters of fuser 60 for receivers. This permits printer 100 to print on receivers of various thicknesses and surface finishes, such as glossy or matte.

Image data for writing by printer 100 can be processed by a raster image processor (RIP; not shown), which can include a color separation screen generator or generators. The output of the RIP can be stored in frame or line buffers for transmission of the color separation print data to each of respective LED writers, e.g. for black (K), yellow (Y), magenta (M), cyan (C), and red (R), respectively. The RIP or color separation screen generator can be a part of printer 100 or remote therefrom. Image data processed by the RIP can be obtained from a color document scanner or a digital camera or produced by a computer or from a memory or network which typically includes image data representing a continuous image that needs to be reprocessed into halftone image data in order to be adequately represented by the printer. The RIP can perform image processing processes, e.g. color correction, in order to obtain the desired color print. Color image data is separated into the respective colors and converted by the RIP to halftone dot image data in the respective color using matrices, which comprise desired screen angles (measured counterclockwise from rightward, the +X direction) and screen rulings. The RIP can be a suitably-programmed computer or logic device and is adapted to employ stored or computed matrices and templates for processing separated color image data into rendered image data in the form of halftone information suitable for printing. These matrices can include a screen pattern memory (SPM).

Each printing module 31, 32, 33, 34, 35 includes various components. For clarity, these are only shown in printing module 32.

Around photoreceptor 25 are arranged, ordered by the direction of rotation of photoreceptor 25, charger 21, exposure subsystem 22, and toning station 23. As described above, charger 21 produces a uniform electrostatic charge on photoreceptor 25 or its surface. Exposure subsystem 22, which can include a laser, one or more LEDs, or a linear LED array, selectively image-wise discharges photoreceptor 25 to produce a latent image. Toning station 23 (also called a development station in the art) applies toner to the photoreceptor to develop the latent image into a visible image. Toner can be applied to either the charged or discharged parts of the latent image. Transfer subsystem 50 then transfers the visible image from photoreceptor 25 to a receiver moving through transfer subsystem 50.

Various parameters of all these components can be selected to control the operation of printer 100. In an embodiment, charger 21 is a corona charger including a grid between the corona wires (not shown) and photoreceptor 25. Voltage source 21a applies a voltage to the grid to control charging of photoreceptor 25. In an embodiment, a voltage bias is applied to toning station 23 by voltage source 23a to control the electric field, and thus the rate of toner transfer, from toning station 23 to photoreceptor 25. In an embodiment, a voltage is applied to a conductive base layer of photoreceptor 25 by voltage source 25a before development, that is, before toner is applied to photoreceptor 25 by toning station 23. The applied voltage can be zero; the base layer can be grounded. This also provides control over the rate of toner deposition during development. In an embodiment, the exposure applied by exposure subsystem 22 to photoreceptor 25 is controlled by LCU 99 to produce a latent image corresponding to the desired print image. Exposure subsystem 22 can include one or more LEDs, or a laser and a raster optical scanner (ROS). All of these parameters can be changed, as described below.

Further details regarding printer 100 are provided in U.S. Pat. No. 6,608,641, issued on Aug. 19, 2003, to Peter S. Alexandrovich et al., and in U.S. Publication No. 2006/0133870, published on Jun. 22, 2006, by Yee S. Ng et al., the disclosures of which are incorporated herein by reference.

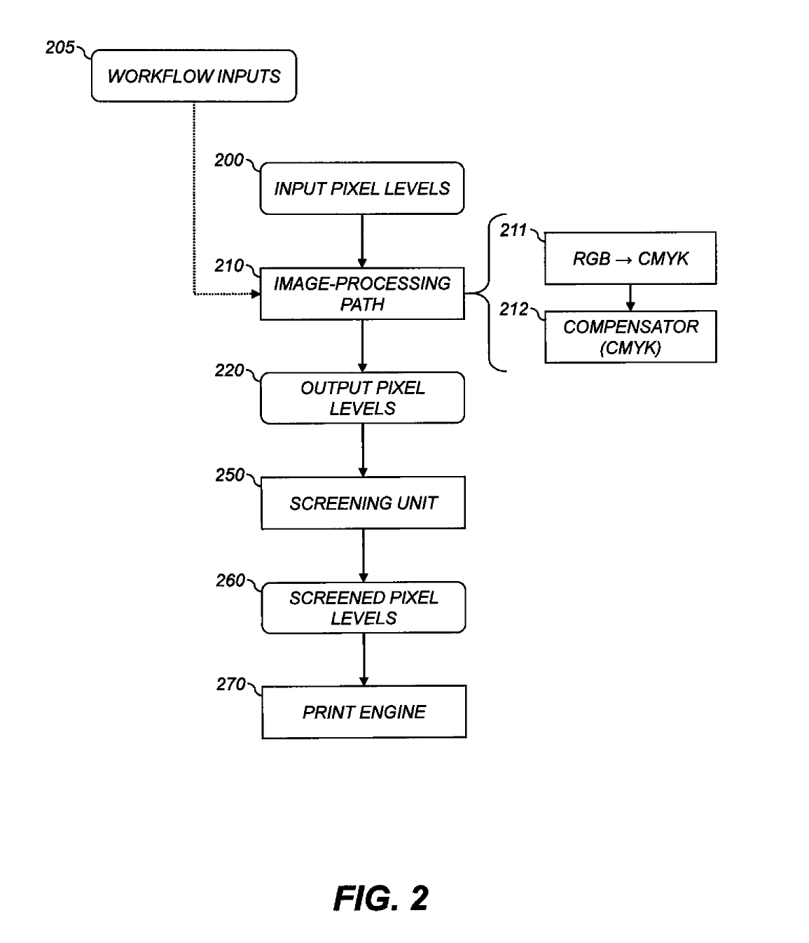

FIG. 2 shows a data-processing path useful with the present invention, and defines several terms used herein. Printer 100 (FIG. 1) or corresponding electronics (e.g. the DFE or RIP), described herein, operate this datapath to produce image data corresponding to exposure to be applied to a photoreceptor, as described above. The datapath can be partitioned in various ways between the DFE and the print engine, as is known in the image-processing art.

The following discussion relates to a single pixel; in operation, data processing takes place for a plurality of pixels that together compose an image. The term “resolution” herein refers to spatial resolution, e.g. in cycles per degree. The term “bit depth” refers to the range and precision of values. Each set of pixel levels has a corresponding set of pixel locations. Each pixel location is the set of coordinates on the surface of receiver 42 (FIG. 1) at which an amount of toner corresponding to the respective pixel level should be applied.

Printer 100 receives input pixel levels 200. These can be any level known in the art, e.g. sRGB code values (0 . . . 255) for red, green, and blue (R, G, B) color channels. There is one pixel level for each color channel. Input pixel levels 200 can be in an additive or subtractive space. Image-processing path 210 converts input pixel levels 200 to output pixel levels 220, which can be cyan, magenta, yellow (CMY); cyan, magenta, yellow, black (CMYK); or values in another subtractive color space. Output pixel level 220 can be linear or non-linear with respect to exposure, L*, or other factors known in the art.

Image-processing path 210 transforms input pixel levels 200 of input color channels (e.g. R) in an input color space (e.g. sRGB) to output pixel levels 220 of output color channels (e.g. C) in an output color space (e.g. CMYK). In various embodiments, image-processing path 210 transforms input pixel levels 200 to desired CIELAB (CIE 1976 L*a*b*; CIE Pub. 15:2004, 3rd. ed., §8.2.1) values or ICC PCS (Profile Connection Space) LAB values, and thence optionally to values representing the desired color in a wide-gamut encoding such as ROMM RGB. The CIELAB, PCS LAB or ROMM RGB values are then transformed to device-dependent CMYK values to maintain the desired colorimetry of the pixels. Image-processing path 210 can use optional workflow inputs 205, e.g. ICC profiles of the image and the printer 100, to calculate the output pixel levels 220. RGB can be converted to CMYK according to the Specifications for Web Offset Publications (SWOP; ANSI CGATS TR001 and CGATS.6), Euroscale (ISO 2846-1:2006 and ISO 12647), or other CMYK standards. In various embodiments, image-processing path 210 includes RGB-to-CMYK converter 211 followed by compensator 212, which compensates for color errors as described below.

Input pixels are associated with an input resolution in pixels per inch (ippi, input pixels per inch), and output pixels with an output resolution (oppi). Image-processing path 210 scales or crops the image, e.g. using bicubic interpolation, to change resolutions when ippi≠oppi. The following steps in the path (output pixel levels 220, screened pixel levels 260) are preferably also performed at oppi, but each can be a different resolution, with suitable scaling or cropping operations between them.

Screening unit 250 calculates screened pixel levels 260 from output pixel levels 220. Screening unit 250 can perform continuous-tone (processing), halftone, multitone, or multi-level halftone processing, and can include a screening memory or dither bitmaps. Screened pixel levels 260 are at the bit depth required by print engine 270.

Print engine 270 represents the subsystems in printer 100 that apply an amount of toner corresponding to the screened pixel levels to a receiver 42 (FIG. 1) at the respective screened pixel locations. Examples of these subsystems are described above with reference to FIGS. 1-3. The screened pixel levels and locations can be the engine pixel levels and locations, or additional processing can be performed to transform the screened pixel levels and locations into the engine pixel levels and locations.

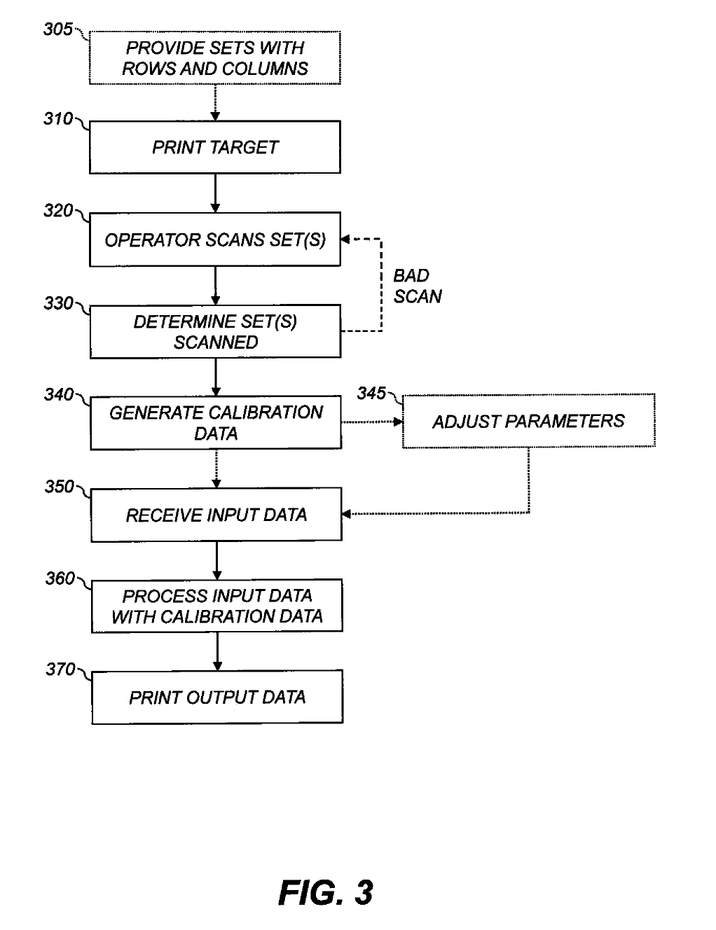

FIG. 3 is a flowchart of a method of providing calibration data for a printer according to various embodiments. Processing begins with step 310.

In step 310, a calibration target is printed using the printer. The target includes first and second patch sets, each patch set including a plurality of test patches. The sets can optionally be provided beforehand, each set with a plurality of columns or rows of patches, and each column or row including a plurality of patches (step 305). Other arrangements of patches can be employed, including intermingling patches from different sets, arranging each set's patches contiguously to each other, or various combinations. More than two sets can also be printed. Step 310 is followed by step 320.

In step 320, an operator scans one or both sets using an external scanner to provide scanned patch data. In an embodiment, a handheld scanner is used, preferably a handheld spectroradiometer. In an embodiment, the operator scans all the patches in any set he scans; in another embodiment, the operator does not scan all the patches in at least one of the sets he scans. Patches from one set can be scanned contiguously in time, or patches from multiple sets can be scanned interleaved. Step 320 is followed by step 330. As used herein, “measured” and “scanned” are synonymous when referring to the operator's scanning test patches to provide scanned patch data. In various embodiments, the first set is required to be scanned and the second set can optionally be scanned. Calibration data are generated regardless of the operator's choice of whether to scan the second set.

In step 330, a processor is used to automatically determine, from received scanned patch data, which set(s) have been scanned. This is discussed in further detail below. The processor can be a CPU, GPU, FPGA, ASIC, PAL, PLD, microcontroller, or other device adapted to execute a software program or flow data through logic circuits to determine which set(s) were scanned. Step 330 is followed by step 340.

In various embodiments, the processor checks whether the number of patches scanned is equal to the number expected. The processor can also check other parameters to determine whether a full set of scanned patch data was collected. If a full set was not collected, the processor prompts the operator to scan the missing patches, or re-scan all patches, and the next step is step 320. This is shown in FIG. 3 by the arrow labelled “bad scan.”

In step 340, calibration data for the printer are automatically generated using the scanned patch data. This is discussed in further detail below. Step 340 is optionally followed by steps 345 or 350.

In an embodiment, the printer is operated once the calibration data are generated. In step 350, input data for a job to be printed are received. Step 350 is followed by step 360.

In step 360, the input data are automatically processed with the calibration data to produce output data. This processing can be performed using a processor (e.g., in compensator 212 shown in FIG. 2), as discussed above. In one embodiment, the calibration data can include one or more transformation table(s) mapping input data to output data, and the processor can look up each input data value in the transformation table(s) to retrieve the output data. The table(s) can include a sampling of the possible input data values, and interpolation between the values in the table(s) can be used to produce output data values for input data values between sampling points. In another embodiment, step 340 can generate calibration data including an ICC profile, and step 360 can process the input data with the generated ICC profile to provide the output data. Step 360 is followed by step 370.

In step 370, the output data are printed using the printer. In this way an accurate representation of the input data is produced on the printer, and color errors and other errors in printing are compensated for by the calibration data. This provides improved image quality compared to printing without calibration.

In another embodiment, the parameters of the printer are also adjusted to improve image quality. In step 345, in response to the calibration data and before printing the output data, the exposure, photoreceptor voltage before development, charger grid voltage, toning station bias, or any combination thereof is automatically adjusted. These parameters are discussed in more detail above. This adjustment is performed in combination with the processing of the input data (step 360) to provide further improvements in image quality. Step 345 is followed by step 350.

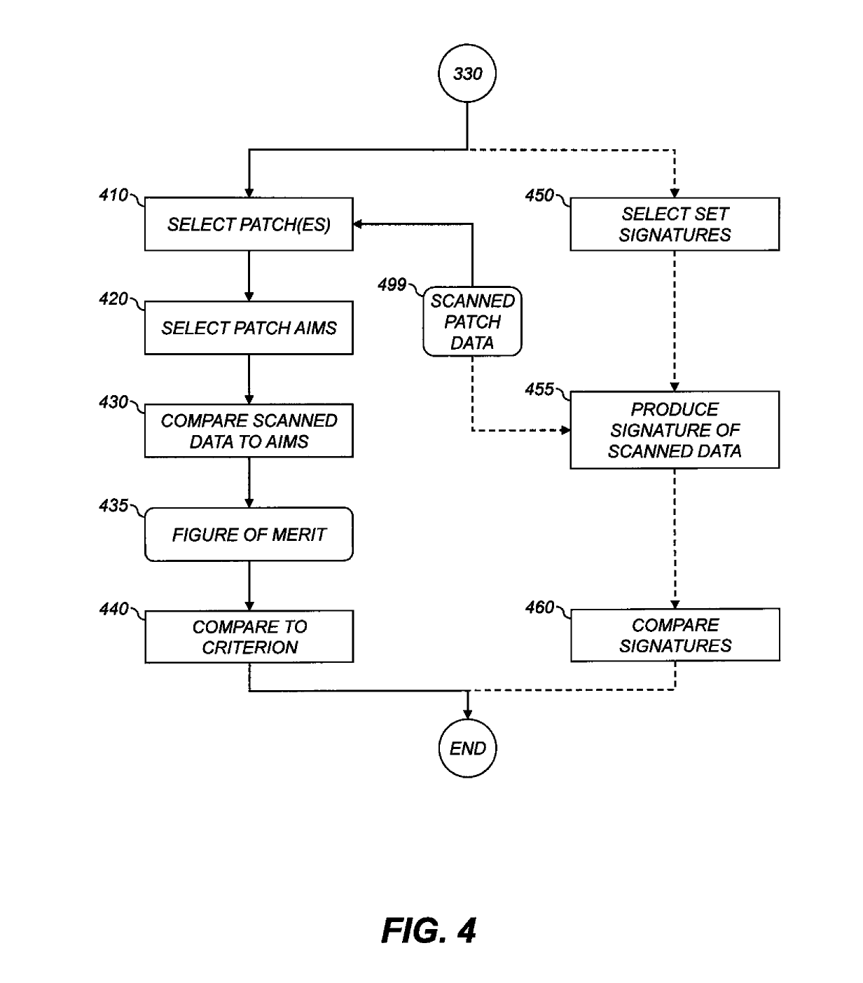

FIG. 4 is a flowchart of details of various embodiments of step 330 (FIG. 3). One embodiment is shown with solid arrows and the other is shown with dashed arrows.

In the first embodiment shown (solid arrows), the determining step (step 330) begins with step 410. In step 410, one or more of the scanned patches whose scanned patch data 499 is above a selected threshold are selected. For example, patches with densities (D) above the threshold (i.e., darker than the threshold), luminances (Y) or lightnesses (L*) above the threshold (i.e., lighter than the threshold), or saturations (C*) above the threshold (i.e., farther from neutral than the threshold) can be selected. The units of measurement of the scanned patch data, and the thresholds, can be selected according to the measurement devices available and the requirements of the system. This step uses patches with values above a threshold since they have higher signal-to-noise ratios than patches with values below the threshold, and are therefore more reliable for determining which sets have been scanned than the lower signal-to-noise patches. In one embodiment, step 410 is followed by step 420.

In step 420, respective patch aims are selected or received for the selected scanned patches in each set. The patch aims can be expressed in various ways selected according to the measurement device and printer hardware. For example, scanner code values, densities, CIELAB values, target spectra (e.g., 400 . . .750 nm at 5 nm intervals) under a given illuminant, or tristimulus values can be used. Step 420 is followed by step 430.

In step 430, the respective scanned patch data of the selected scanned patches are compared to the respective patch aims in each set to produce a respective figure of merit for each set indicating how closely the selected scanned patch data match the patch aims for that set.

Step 430 produces merit 435, which is provided to step 440. The figure of merit can be expressed in CIELAB delta values (e.g., ΔE*), CIELUV deltas, hue-angle differences, tristimulus value differences, or other color-difference units, and can include one value, multiple values, or a combination of values by averaging, taking the RMS average, taking the maximum, taking the minimum, taking the median, finding the standard deviation, or other computational techniques. In an embodiment, the figure of merit is the CIELAB RMS ΔE* for the patches in the set.

In step 440, the respective figures of merit are compared to a selected criterion or criteria to determine whether the respective set has been scanned. That is, each figure of merit 435 is compared to one or more of the other figure(s) of merit, or to one or more reference criteria, to determine which set was scanned. In an embodiment, the figure of merit is CIELAB RMS ΔE*, and the processor selects the lowest RMS ΔE*. That is, the scanned patches are compared to the patch aims of a plurality of sets to produce one RMS ΔE* for each set. That RMS ΔE* will be lowest for the set to which the measured data is closest in color. Therefore, the processor determines that the set with the lowest RMS ΔE* was indeed the set scanned.

In various embodiments, the computation of figure of merit (step 430) and the comparison step (step 440) can include correction for systematic errors, i.e., errors due to known, presumed, or inferred mis-calibration in printing. For example, if not enough black colorant is being applied, all patches will have higher CIELAB L* values than they should, and medium-saturation colors will have higher CIELAB C* values than they should (because neutral content is not being mixed in as it should be). The processor can compare the scanned patch data values for some or all of the scanned patches, including patches whose scanned patch data is not above the selected threshold, to locate systematic errors.

In one example, CIELAB RMS ΔE* is the expected figure of merit. The processor can compare the ΔL* values for each patch. If all of the ΔL* values are positive, and the distribution of ΔL* values corresponds to a failure in the black channel, the processor can take appropriate action. The processor can report to the operator that a failure in the black channel (e.g., out of ink or toner) has occurred. The processor can also change the figure of merit from RMS ΔE* to RMS ΔC*. In this way, large ΔL* errors due to the black-channel error will not overpower lower-magnitude ΔC* which are more representative of which set has been scanned. This provides improved accuracy in determining which set was scanned, and can provide additional early-warning diagnostic information to the operator.

In various embodiments, patches from one set are not scanned contiguously in time. That is, not all the patches from one set are scanned with no intervening patches from other sets. The processor then determines in which set each scanned patch belongs. This can be performed in various ways. In one embodiment, each patch's scanned patch data is compared to the patch aims of all of the patches on the test target to compute a figure of merit for that scanned patch data with respect to that patch's aims. For example, for a ten-patch target, the processor would compute 100 (=10*10) figures of merit, one for each combination of a scanned patch's data and a patch aim. For each patch on the test target, the scanned patch data indicating that scanned patch data most closely matches the patch aim is selected as the scanned patch data for that patch. In another embodiment, these figures of merit (e.g., 100 for a 10-patch set) are computed, and minimization or regression is performed to determine the mapping between scanned patch data and patch aims that provides an overall match meeting a selected criterion. For example, the mapping can be selected to mathematically minimize RMS ΔE* of all 10 patches, rather than minimizing the individual ΔE* of each of the 10 patches. This advantageously reduces the likelihood of false matches due to significant color errors in printing. The techniques described above for detection and correction of systematic error can also be employed.

In various embodiments, the external scanner includes an accelerometer or other locating device, or operates in conjunction with an external location device such as a magnetic triangulator, to provide information about the locations of the scanned patches on the test target. This information is used in addition to the scanned patch data and patch aims to determine which patch(es) or set(s) have been scanned.

In the second embodiment shown in FIG. 4 (dashed arrows), the determining step (step 330) begins with step 450. Step 450 selects respective signatures for the first and second patch sets on the target, as discussed below. Step 455 receives scanned patch data 499 and produces a signature of the scanned patch data. Steps 450 and 455 can be performed in either order. Step 460 compares the produced signature for the scanned patch data to the selected signatures for the patch sets to determine which patch sets have been scanned.

Each patch set has a signature. As used herein, the term “signature” means a collection of data uniquely identifying the patch set. That is, the first and second patch sets have different signatures. In various embodiments, the signature of a set is a list or bitmask of which patches in that set have a density (or color, saturation, lightness, or other quantities, as described above) greater than (or equal to) a selected threshold, or less than (or equal to) a selected threshold. That is, the positions of notable patches within the set are uniquely indicative of the set, where notable patches are those meeting the selected threshold criterion. Sets are selected so that no two sets have the same pattern of notable patches, that is, so that each set has a unique signature.

In one example, the signature is a bitmask of patches having densities greater than or equal to the threshold D=1.0. The first patch set has eight patches with respective densities of 3.1, 0.41, 0.59, 2.6, 0.5, 3.5, 0.89, and 0.79, so its signature is 10010100. The second patch set has eight patches with respective densities of 3.0, 2.3, 0.84, 0.6, 2.6, 0.43, 3.0, and 0.8, so its signature is 11001010. The Hamming distance (number of changed bits) between the two signatures is

set 1: 10010100

set 2: 11001010

set 1 XOR set 2: 01011110

Hamming distance: 5

where XOR is the binary bitwise exclusive-or operator and the Hamming distance is the number of set (1) bits in the XOR result. The densities of the test patches in each patch set are preferably selected to make the Hamming distance between the sets as large as possible.

Continuing this example, eight patches are measured, and the respective densities of the scanned patch data are 2.9, 0.3, 0.7, 2.1, 0.1, 3.0, 1.1, and 0.9, so the signature of the scanned patch data is 10010110. The Hamming distance is computed between this signature and the two sets' signatures:

| | set 1 | set 2 |
|---|---|---|
| scanned data | 10010110 | 10010110 |
| set signature | 10010100 | 11001010 |
| XOR | 00000010 | 01011100 |
| Hamming | 1 | 4 |

Since the Hamming distance to set 1 is lower than the distance to set 2, the processor determines that set 1 was scanned.

In another example using the same patch sets and thresholds, both sets are scanned to produce 16 scanned patch data values. The scanned data are divided into two eight-patch groups, here denoted A and B. The sixteen density values are (A) 3.0, 0.6, 0.7, 2.3, 0.55, 3.5, 1.1, 0.8; and (B) 3.0, 2.5, 1.2, 0.4, 2.3, 1.0, 3.1, and 1.1. Respective eight-bit set signatures are calculated for each set of eight scanned patch data values, namely 10010110 for A and 11101111 for B. To determine which group of eight measured values corresponds to which set, the Hamming distance is computed to each set (set 1, set 2) for each eight-bit measured-data signature (A, B):

| | set 1 A | set 1 B | set 2 A | set 2 B |
|---|---|---|---|---|
| scanned data | 10010110 | 11101111 | 10010110 | 11101111 |
| set signature | 10010100 | 10010100 | 11001010 | 11001010 |
| XOR | 00000010 | 01111011 | 01011100 | 00100101 |
| Distance | 1 | 6 | 4 | 3 |

In this example, the two lowest Hamming distances are set 1 A (distance=1) and set 2 B (distance=3), which are consistent with each other (that is, the two lowest distances indicate that each group of measured patches belongs to a different set). Therefore, the eight “A” patches are determined to be measurements of the first set, and the eight “B” patches are determined to be measurements of the second set. In cases of inconsistency, the processor can select the mapping of measured patches to sets indicated by the highest number of low Hamming distances, or by the majority of Hamming distances, or select the alternative corresponding to the single lowest Hamming distance regardless of other distances.

In another embodiment of a signature, the signature is the parameters describing a curve fit through the measured data (e.g., density, color, or others as described above). For example, the coefficients of a least-squares polynomial (degree>=0) fit, or the coordinates of the knots of a selected spline fit, can be used as a signature. In these embodiments, instead of Hamming distance, the two signatures are curves to be compared. For example, the integral of the absolute value of the difference between a measured-data signature and a set's signature can be taken for each set, and the set with the smallest resulting value selected as that corresponding to the measured data.

In various embodiments, the test patches are selected to provide signatures robust against operator error. For example, two sets having bitmask signatures 1010 and 0101 can be confused if the operator forgets to scan the first patch. Signatures 1010 and 0110, however, can be differentiated even if cyclically permuted. The operator preferably scans all the patches of a set in order, but this is not required. If the operator scans patches out of order, their color characteristics and densities can be considered to determine their positions in the scan, and each patch can be individually assigned to a set based on its colorimetric proximity to the patches in the sets (for example, assume each measured patch has the smallest CIELAB ΔE* difference from the patch in the set it corresponds to).

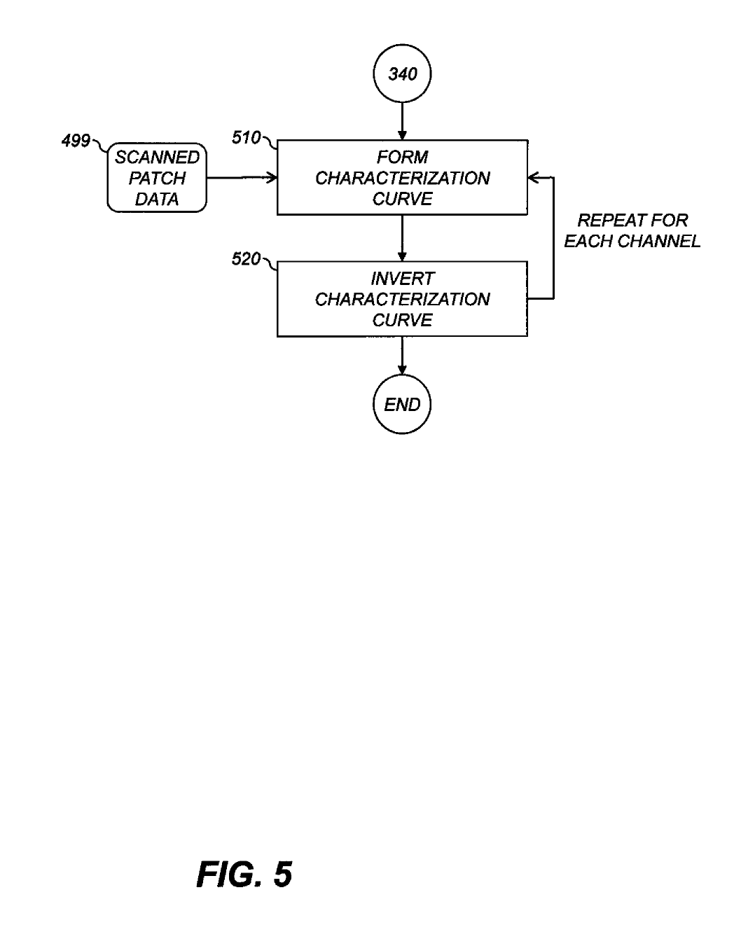

FIG. 5 is a flowchart of details of one embodiment of step 340 (FIG. 3). In this embodiment, calibration data are generated starting in step 510. In this embodiment, the test patches include patches for the subtractive primary colors (cyan, magenta, yellow, and black), and for any other color channel present in the printer (e.g., red or light black). For each color channel (CMYK+others), test patches are provided to cover the range of aim densities intended to be printed (e.g., 0% (a white patch, possibly using a single patch for all channels) to 100% (maximum laydown of the colorant in a single channel)). The patches are measured, as described above with reference to step 320 (FIG. 3).

In step 510, a single characterization curve (or table) is formed for each channel by interpolating or fitting the curve of (aim density, measured density) points provided in scanned patch data 499. Step 510 is followed by step 520, in which the characterization curve is inverted to produce a curve that transforms desired density on the paper into the aim density input to the printer to produce that desired density. Steps 510 and 520 are repeated for each channel.

In an embodiment, the inverted characterization curve is expressed in terms of input pixel levels 200 (FIG. 2) to image-processing path 210 (FIG. 2), and each successive input pixel level 200 represents a constant increase in reproduced CIELAB L*. In another embodiment, the inverted characterization curve approximates a typical 20% dot-gain calibration curve. Color balance can also be adjusted as known in the art. Additional embodiments useful with this method are described in commonly-assigned U.S. Pat. No. 7,548,343 to Ng et al., issued Jun. 16, 2009, the disclosure of which is incorporated herein by reference.

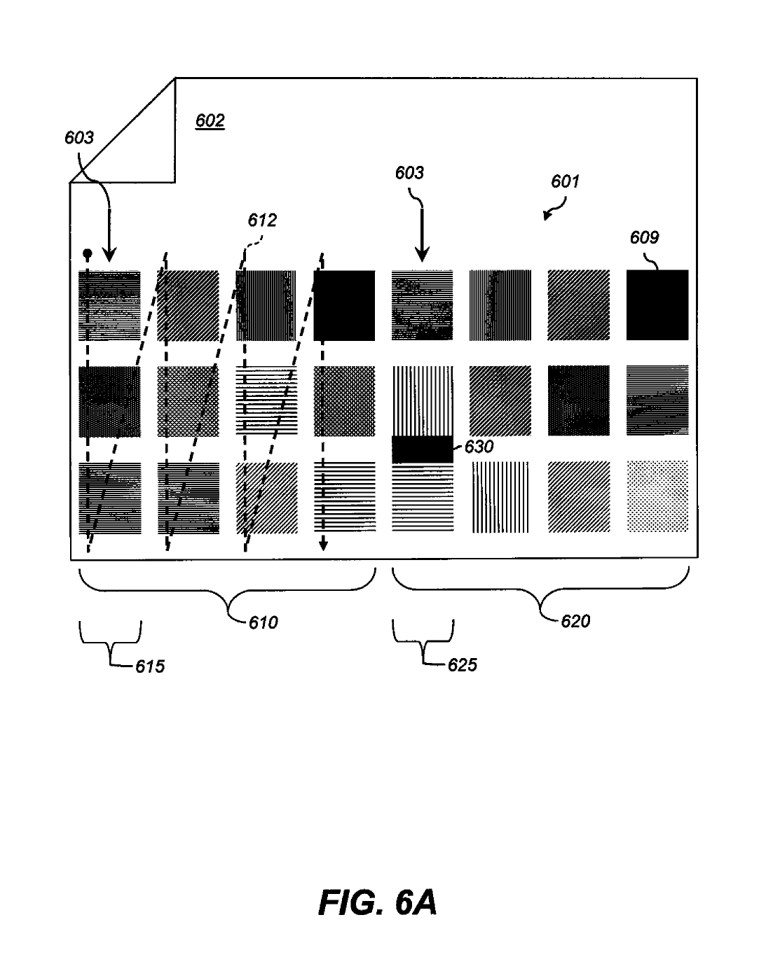

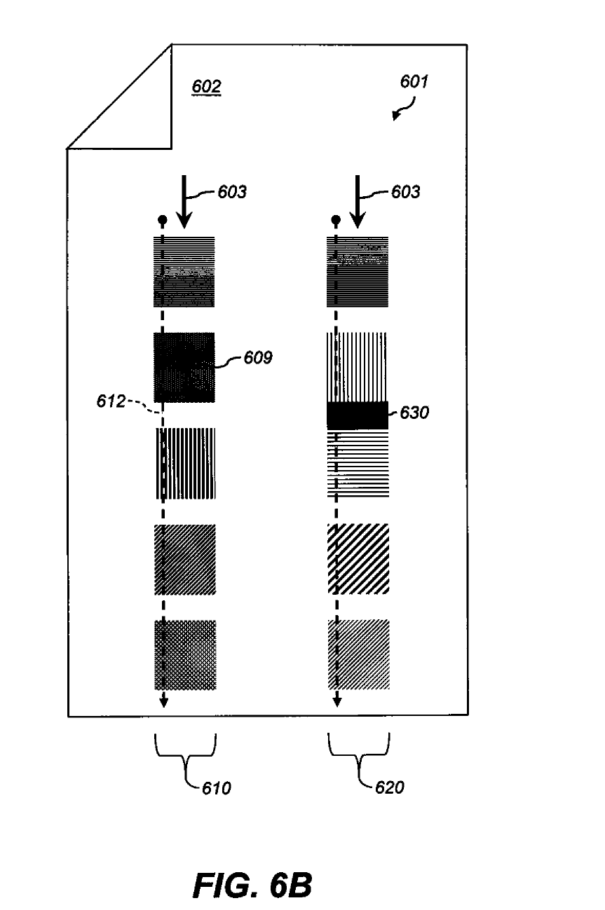

FIG. 6A is a representation of a test target according to an embodiment. Test target 601 is printed on page 602. Patch sets 610, 620 each contain 12 test patches (e.g. test patch 609), the patches arranged in three rows and four columns. Different hatching patterns and densities in FIG. 6 represent different colors and densities of patches. In this example, the top row of patches, left-to-right, is full-saturation CYMK in patch set 610 and full-saturation CMYK in patch set 620. First column 615 of patch set 610, top-to-bottom, is full C, a mid-gray, and another full C. First column 625 of patch set 620, top-to-bottom, is full C, a mid-tone M, and a mid-tone C. Printed arrow 603 is printed on page 602 to indicate to the operator where patch sets 610, 620 start. The operator scans top-to-bottom, left-to-right, as indicated for patch set 610 by scan path 612. In some embodiments, spacing patches 630 having high densities are located between patches of low densities to facilitate automatic detection of the edges of the test patches. The colors or densities of the spacing patches can be measured or ignored.

In various embodiments, step 410 (FIG. 4) of selecting one or more of the scanned patches whose scanned patch data is above a selected threshold, one or more of the patches in a selected column are selected. For example, first column 615 can be selected, and one or more of the test patches therein can be selected, provided those test patches have scanned patch data above a selected threshold.

In various embodiments, the selected column is the first column scanned by the operator, e.g., first column 615. This permits steps 420, 430, and 440 (FIG. 4) of processing the scanned data to be performed while the operator is scanning the remaining patches in the set being scanned. This can reduce total processing time and improve throughput in the calibration process, thereby reducing printer downtime for calibration.

FIG. 6B is a representation of a test target according to another embodiment. Page 602, arrows 603, and spacing patch 630 are as described above with reference to FIG. 6A. Test target 601 is printed on page 602. Patch sets 610, 620 each contain a strip (row or column) of test patches (e.g. test patch 609). In this example, patch set 610, top to bottom, is full-saturation C, dark gray (K), dark M, mid-tone Y, and light gray. Patch set 620, top to bottom, is full C, light M, light C, dark Y, and light Y. The operator scans top to bottom, as indicated for patch set 610 by scan path 612. Scanning and processing can be overlapped as described above. In one example, the operator scans patch set 610 first. While the operator is scanning patch set 620, the processor determines that patch set 610 was scanned first. In other embodiments, the processor determines which set was scanned first before the operator begins scanning the second set. In either case, the processor is ready to process measured data for patch set 620 as soon as it is provided by the scanner, without delay to determine that patch set 620 was scanned second.

In various embodiments, the patches in each set can also be arranged irregularly on page 602.

In an embodiment, the first patch set provides data for coarse calibration, and the second (or any other) patch set provides data for fine calibration. That is, the patches in the second patch set fill in the gaps between patches in the first patch set. In another embodiment, the first patch set provides data for gamut boundary calibration, and the second patch set provides data for gamut interior calibration.

In various embodiments, the second patch set includes a plurality of patches located within the gamut surface or gamut boundary of the patches in the first patch set but not themselves found in the first patch set. The gamut surface of the patches in the first patch set can be computed as a convex hull or other estimated enclosing surface, and can be computed in a 2-D or 3-D color space, such as CIELAB. It is not required that all patches in the first patch set be located on the gamut surface; some patches in the first patch set can be interior to the gamut surface, and some patches in the second patch set can be located on the gamut surface.

The patches in each patch set, and the arrangement of the sets, can be selected based on the specifics of the printer, media, colorant, or any combination. Multiples of any patch can be provided in the same set or in different sets to increase the signal-to-noise ratio of measurements of those patches. In an embodiment, at least two patches of each neutral-scale (C*≈0 or C*<0.5) color are present in the two patch sets taken together.

The patches preferably span the output gamut of the printer as configured, so that, for example, color errors in only one hue sector are not overlooked due to insufficient data. More closely-spaced patches can be provided in areas of the gamut where the printer is known to exhibit variation between closely-spaced colors. Correspondingly, where variations are small between widely-spaced colors, more widely-spaced patches can be used.

Patches of the primaries (e.g., C, M, Y, K) are preferably present in at least one set, and preferably at a variety of density levels. Patches of the secondaries (e.g., R, G, B) can also be used in at least one set, optionally at various density levels. Patches of colors to which the eye is particularly sensitive (e.g., sky, grass, and human skin) can be included in a set to provide effective calibration for those particular color ranges.

Patches are selected to balance the time to scan with the desired accuracy of calibration; both increase with increasing number of patches. If the number of patches is too high, the calibration will take too long. If the number of patches is too low, the calibration will not be sufficiently accurate.

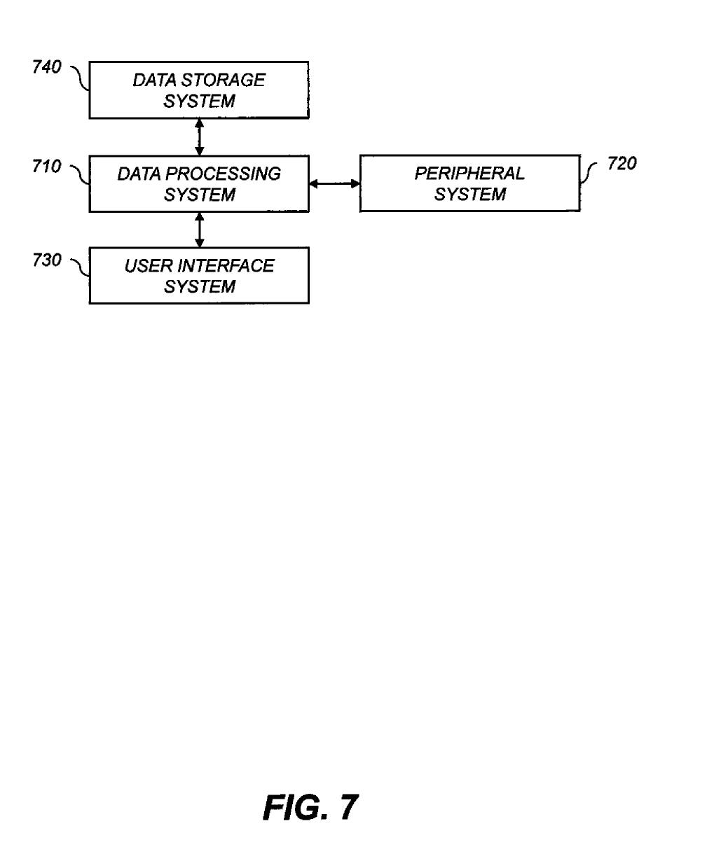

FIG. 7 is a high-level diagram showing the components of a processing system useful with various embodiments. The system includes a data processing system 710, a peripheral system 720, a user interface system 730, and a data storage system 740. Peripheral system 720, user interface system 730 and data storage system 740 are communicatively connected to data processing system 710.

Data processing system 710 includes one or more data processing devices that implement the processes of the various embodiments of the present invention, including the example processes described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device for processing data, managing data, or handling data, whether implemented with electrical, magnetic, optical, biological components, or otherwise.

Data storage system 740 includes one or more processor-accessible memories configured to store information, including the information needed to execute the processes of the various embodiments of the present invention, including the example processes described herein. Data storage system 740 can be a distributed processor-accessible memory system including multiple processor-accessible memories communicatively connected to data processing system 710 via a plurality of computers or devices. On the other hand, data storage system 740 need not be a distributed processor-accessible memory system and, consequently, can include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMs.

The phrase “communicatively connected” is intended to include any type of connection, whether wired or wireless, between devices, data processors, or programs in which data can be communicated. The phrase “communicatively connected” is intended to include a connection between devices or programs within a single data processor, a connection between devices or programs located in different data processors, and a connection between devices not located in data processors at all. In this regard, although the data storage system 740 is shown separately from data processing system 710, one skilled in the art will appreciate that data storage system 740 can be stored completely or partially within data processing system 710. Further in this regard, although peripheral system 720 and user interface system 730 are shown separately from data processing system 710, one skilled in the art will appreciate that one or both of such systems can be stored completely or partially within data processing system 710.

Peripheral system 720 can include one or more devices configured to provide digital content records to data processing system 710. For example, peripheral system 720 can include digital still cameras, digital video cameras, cellular phones, or other data processors. Data processing system 710, upon receipt of digital content records from a device in peripheral system 720, can store such digital content records in data storage system 740. Peripheral system 720 can also include a printer interface for causing a printer to produce output corresponding to digital content records stored in data storage system 740 or produced by data processing system 710.

User interface system 730 can include a mouse, a keyboard, another computer, or any device or combination of devices from which data is input to data processing system 710. In this regard, although peripheral system 720 is shown separately from user interface system 730, peripheral system 720 can be included as part of user interface system 730.

User interface system 730 also can include a display device, a processor-accessible memory, or any device or combination of devices to which data is output by data processing system 710. In this regard, if user interface system 730 includes a processor-accessible memory, such memory can be part of data storage system 740 even though user interface system 730 and data storage system 740 are shown separately in FIG. 1.

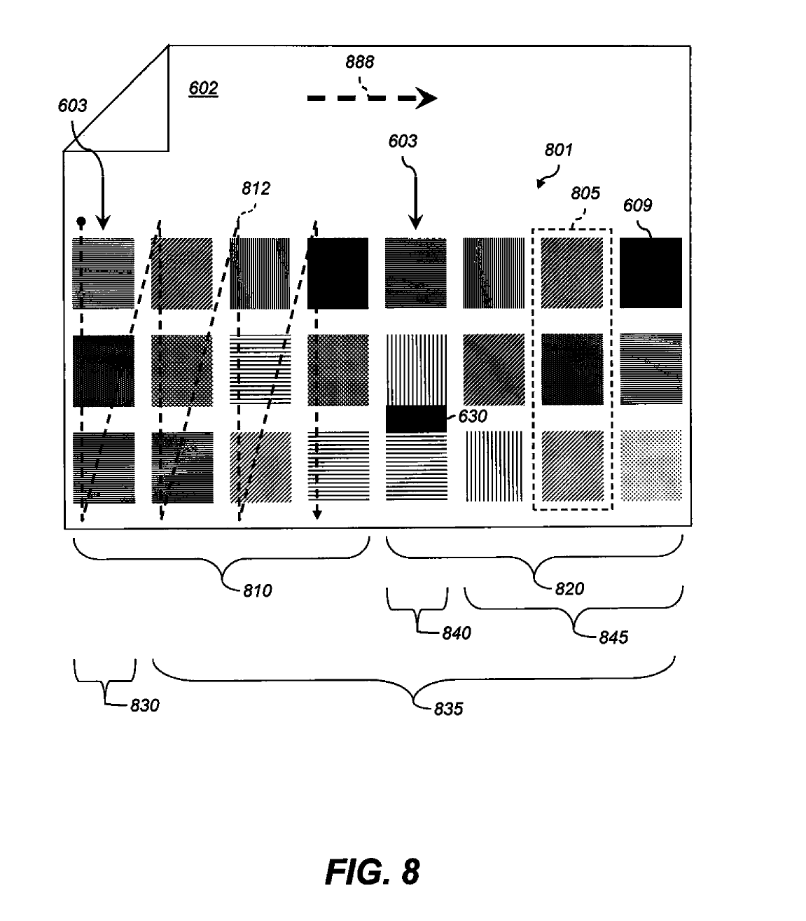

FIG. 8 is a representation of a test target according to another embodiment. Page 602, arrows 603, and spacing patch 630 are as described above with reference to FIG. 6A. Test target 801 is printed on page 602. Required patch set 820 includes test patches (e.g. test patch 609) that are required to be scanned in order to provide calibration data. Optional patch set 810 includes test patches that can be scanned, e.g., to improve the quality or range of calibration, but are not required to be scanned. Optional patch set 810 is arranged spatially on the receiver before required patch set 820 in scan order 888. Each patch set 810, 820 includes at least one test strip (e.g., test strip 805), and each test strip includes a plurality of test patches. Test strips can be vertical, horizontal, diagonal, or another orientation. Test strips can be parallel or non-parallel. Within each set, strips are scanned sequentially, as indicated by scan path 812. FIG. 8 is discussed further below.

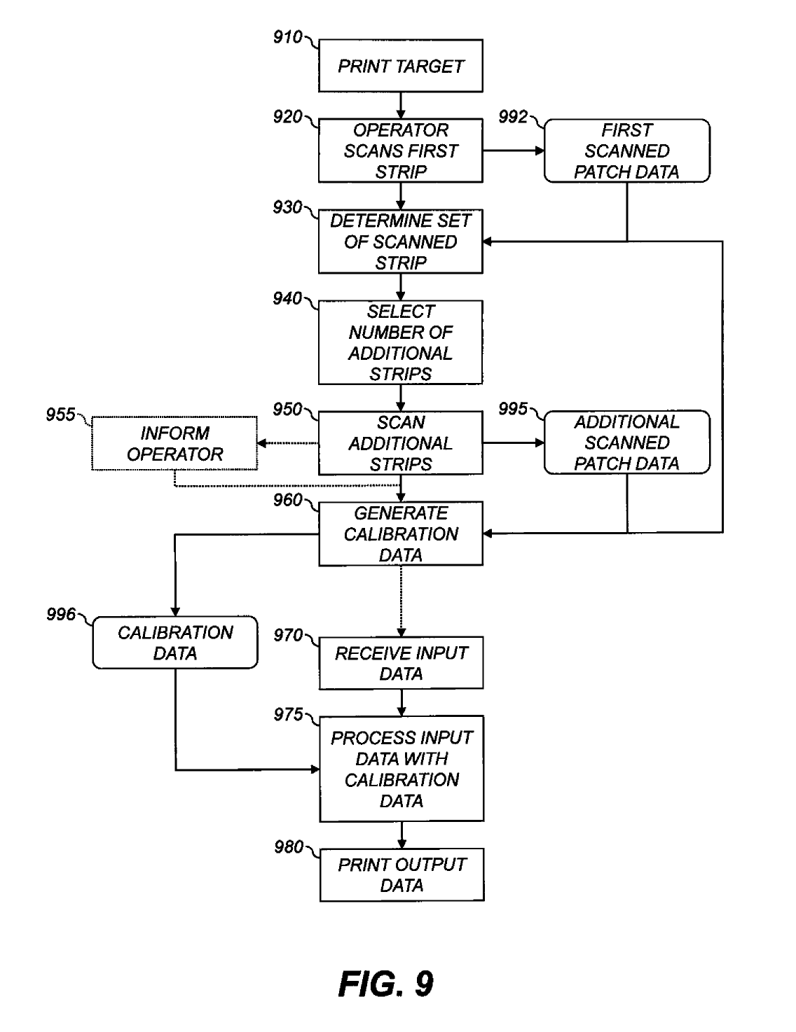

FIG. 9 is a flowchart of a method of providing calibration data for a printer according to another embodiment. This method can be used with test targets such as that shown in FIG. 8. Processing begins with step 910.

In step 910, a calibration target is printed on a receiver using the printer. The target includes a required patch set and an optional patch set, the optional patch set is arranged spatially on the receiver before the required patch set in a scan order, each patch set includes at least one test strip, and each test strip including a plurality of test patches. An example of a target useful with this embodiment is shown in FIG. 8, described above. Step 910 is followed by step 920. In step 920, an operator scans a first test strip of a first one of the patch sets using an external scanner. Step 920 is followed by step 930 and produces first scanned patch data 992. Data 992 are provided to steps 930 and 960.

In step 930, a processor is used to automatically determine whether the first one of the patch sets is the required set or the optional set based on the first scanned patch data, which the processor receives. This determination can be made analogously to the determination described above with respect to FIG. 4 of whether the first set or the second set was scanned. Step 930 is followed by step 940.

In step 940, a number is selected of additional strips to scan corresponding to the determined first one of the patch sets. For example, referring back to FIG. 8, if the first strip scanned is strip 830 (the first strip of optional patch set 810), the seven strips in group 835 remain to be scanned. Therefore, the selected number of additional strips is seven. If the first strip scanned is strip 840 (the first strip of required patch set 820), the three strips of group 845 remain to be scanned, so the selected number of additional strips is three. Referring back to FIG. 9, step 940 is followed by step 950.

In step 950, the operator scans the selected number of additional strips in the scan order. Step 950 is followed by step 960 and optionally by step 955. Step 950 produces additional scanned patch data 995, which are provided to step 960.

In optional step 955, the operator is informed when the selected number of additional strips has been scanned. The operator can be informed by audio (e.g., a computer beeping or a bell ringing), video (e.g., a message on a computer screen appearing or disappearing, or a lamp lighting or extinguishing), or other sensory modes. Step 955 is followed by step 960.

In step 960, the calibration data for the printer are automatically generated using first scanned patch data 992 and the additional scanned patch data 995, which are received by the processor. Step 960 produces calibration data 996, which are provided to step 975. Step 960 is optionally followed by step 970.

In optional step 970, input data are received representing a job to be printed. Step 970 is followed by step 975. In step 975, the input data are processed with calibration data 996 to provide output data, as discussed above. Step 975 is followed by step 980. In step 980, the output data are printed using the printer.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. The word “or” is used in this disclosure in a non-exclusive sense, unless otherwise explicitly noted.

The invention has been described in detail with particular reference to certain preferred embodiments thereof, but it will be understood that variations, combinations, and modifications can be effected by a person of ordinary skill in the art within the spirit and scope of the invention.

### PARTS LIST

21 charger
21a voltage source
22 exposure subsystem
23 toning station
23a voltage source
25 photoreceptor
25a voltage source
31, 32, 33, 34, 35 printing module
38 print image
39 fused image
40 supply unit
42, 42A, 42B receiver
50 transfer subsystem
60 fuser
62 fusing roller
64 pressure roller
66 fusing nip
68 release fluid application substation
69 output tray
70 finisher
81 transport web
86 cleaning station
99 logic and control unit (LCU)
100 printer
200 input pixel levels
205 workflow inputs
210 image-processing path
211 converter
212 compensator
220 output pixel levels
250 screening unit
260 screened pixel levels
270 print engine
310 print target step
320 operator scans set(s) step
330 determine set(s) scanned step
340 generate calibration data step
345 adjust parameters step
350 receive input data step
360 process input data with calibration data step
370 print output data step
410 select patch(es) step
420 select patch aims step
430 compare scanned data to aims step
435 figure of merit
440 compare to criterion step
450 select signatures step
455 produce signature step
460 compare signatures step
499 scanned patch data
510 form characterization curve step
520 invert characterization curve step
601 test target
602 printed page
603 printed arrow
609 test patch
610 patch set
612 scan path
615 first column
620 patch set
625 first column
630 spacing patch
710 data-processing system
720 peripheral system
730 user-interface system
740 data-storage system
801 test target
805 test strip
810 optional patch set
812 scan path
820 required patch set
830 strip
835 group
840 strip
845 group
888 scan order
910 print target step
920 operator scans first strip step
930 determine set of scanned strip step
940 select number of additional strips step
950 scan additional strips step
955 inform operator step
960 generate calibration data step
970 receive input data step
975 process input data with calibration data step
980 print output data step
992 first scanned patch data
995 additional scanned patch data
996 calibration data

1. A method of providing calibration data for a printer, comprising:
printing a calibration target using the printer, the target including first and second patch sets, each patch set including a plurality of test patches;
an operator scanning one or both sets using an external scanner to provide scanned patch data;
automatically determining, using a processor, which set(s) have been scanned; and
automatically generating calibration data for the printer using the scanned patch data.

2. The method according to claim 1, further including operating the printer by:
receiving input data for a job to be printed;
automatically processing the input data with the calibration data to produce output data; and
printing the output data using the printer.

3. The method according to claim 1, wherein the printer is an inkjet, offset, flexographic, or thermal printer.

4. The method according to claim 1, wherein the printer is an electrophotographic printer.

5. The method according to claim 4, further including, in response to the calibration data and before printing the output data, automatically adjusting the exposure, photoreceptor voltage before development, charger grid voltage, or toning station bias.

6. The method according to claim 1, wherein the determining step includes:
selecting one or more of the scanned patches whose scanned patch data is above a selected threshold;
selecting respective patch aims for the selected scanned patches in each patch set;
comparing the respective scanned patch data of the selected scanned patches to the respective patch aims in each patch set to produce a respective figure of merit for each set indicating how closely the selected scanned patch data match the patch aims for that set; and
comparing the respective figures of merit to a selected criterion to determine whether the respective set has been scanned.

7. The method according to claim 6, further comprising providing each set with a plurality of columns of patches, each column including a plurality of patches, wherein the selecting one or more of the scanned patches step selects one or more of the patches in a selected column.

8. The method according to claim 7, wherein the selected column is the first column scanned by the operator.

9. The method according to claim 1, wherein the determining step includes:
selecting respective signatures for the patch sets;
producing a signature of the scanned patch data; and
comparing the produced signature to the signatures for the patch sets to determine which patch sets have been scanned.

10. The method according to claim 1, wherein the second patch set includes a plurality of patches located within the gamut surface of the patches in the first patch set but not themselves found in the first patch set.

11. A method of providing calibration data for a printer, comprising:
printing a calibration target on a receiver using the printer, the target including a required patch set and an optional patch set, the optional patch set arranged spatially on the receiver before the required patch set in a scan order, each patch set including at least one test strip, each test strip including a plurality of test patches;
an operator scanning a first test strip of a first one of the patch sets using an external scanner to provide first scanned patch data;
automatically determining, using a processor, whether the first one of the patch sets is the required set or the optional set based on the first scanned patch data;
selecting a number of additional strips to scan corresponding to the determined first one of the patch sets;
the operator scanning the selected number of additional strips in the scan order to provide additional scanned patch data; and
automatically generating calibration data for the printer using the first scanned patch data and the additional scanned patch data.

12. The method according to claim 11, further including informing the operator when the selected number of additional strips has been scanned.

13. The method according to claim 11, further including operating the printer by:
receiving input data for a job to be printed;
automatically processing the input data with the calibration data to produce output data; and
printing the output data using the printer.
